(19) United States
(12) Patent Application Publication
(10) Pub. No.: US 2021/0399670 A1
(43) Pub. Date: Dec. 23, 2021

(54) Self-Contained Self-Stowing and Self-Deployable Automatic Tracking Solar Panel System

(71) Applicant: Gary L. Herwood, Tyler, TX (US)

(72) Inventor: Gary L. Herwood, Tyler, TX (US)

(21) Appl. No.: 17/340,142

(22) Filed: Jun. 7, 2021

Related U.S. Application Data
(60) Provisional application No. 63/041,804, filed on Jun. 19, 2020.

(51) Int. Cl. H02S 10/40; G05D 3/10; H02S 30/20; H02S 20/32

(52) U.S. Cl. CPC H02S 10/40; H02S 20/32; H02S 30/20; G05D 3/105

(57) ABSTRACT

An automated self-contained solar panel system includes a weather-tight storage crate having a top side, bottom, and four vertical sides. The storage crate is used to house a first solar array having a primary solar panel mounted on a column and having at least one secondary solar panel slidably engaged with the primary solar panel, and at least one second solar array having a primary solar panel mounted on the column and having at least one secondary solar panel slidably engaged with the primary solar panel, the solar panels of the at least one secondary solar array overlapping the solar panels of the primary solar array in a stowed position, and the solar panels of the at least one secondary solar array extending beyond and not overlapping the solar panels of the primary solar array in a deployed position.

### RELATED APPLICATION

This application claims priority to U.S. Provisional Application No. 63/041,804 filed Jun. 19, 2020, which is incorporated herein by reference in its entirety.

### FIELD

The present disclosure relates to solar energy systems, and in particular, the present disclosure is related to a self-contained self-stowing and self-deployable automatic tracking solar panel system.

### BACKGROUND

Conventional electric power can become unavailable when environmental and/or weather conditions interrupt or destroy power grids. A fossil fuel-based generator may not be able to function as an alternative supply source as the fuel may not be able to be transported to the effected region and/or pumps may not be functioning to supply the fuel from underground tanks. Undeveloped or underdeveloped areas, remote areas, or sparsely populated areas can be without electric power or have limited available power due to the economic inability to build and/or maintain an electricity generation and delivery system; generating electricity on a constant basis using a fossil-fuel based generator is neither economically nor environmentally sustainable.

Most available solar systems are roof-installed or are large ground-installed arrays. Not all roofs are compatible as installation sites for solar energy generation due to solar orientation, size or structural strength. Many areas don't have the land mass for large, commercial-scale arrays. Further, both installation types require long lead times.

### BRIEF DESCRIPTION OF THE DRAWINGS

FIG. 1 is a simplified block diagram an exemplary embodiment of a self-contained self-stowing and self-deployable automatic tracking solar panel system in various stages of deployment according to the teachings of the present disclosure;

FIGS. 2-10 are perspective views of an exemplary embodiment of a self-contained self-stowing and self-deployable automatic tracking solar panel system in various stages of deployment according to the teachings of the present disclosure;

FIG. 11 is a simplified flowchart of an exemplary embodiment of a self-contained self-stowing and self-deployable automatic tracking solar panel method according to the teachings of the present disclosure.

### DETAILED DESCRIPTION

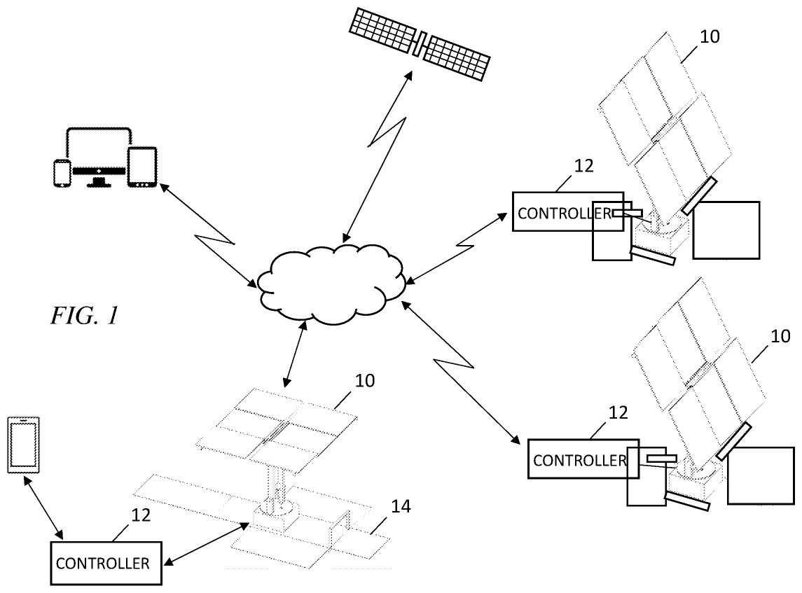

FIG. 1 is a simplified block diagram an exemplary embodiment of several self-contained self-stowing and self-deployable automatic tracking solar panel systems 10 according to the teachings of the present disclosure. The system and method 10 comprise a “smart” solar power generating system in communication or coupled to a controller 12 that enables it to be “ready-to-use” without hands-on operations. The solar panel system 10 may deploy automatically, deploy according to a predetermined schedule, and/or deploy in response to remote control via some form of wireless communications (e.g., via WiFi, Bluetooth, Cellular, satellite networks). Optionally, the controller 12 is able to use GPS to determine the site (latitude and longitude) of the solar panel system 10 to always keep the solar panel arrays at the most advantageous orientation to the sun. The controller 12 may also receive and analyze weather information, including current and forecast for the weather, via its links to the internet or satellite. In case of an impending threatening inclement weather event (e.g., high winds, lightning storms, hail, etc.) or upon command, the controller 12 can return the solar arrays to their stowed position and close the weather-tight shipping crate 14 to protect the system. The controller 12 can restore the system to the appropriate operational position when the weather is analyzed as safe or upon command. The commands may be issued via a remote device such as a mobile phone or computer or via a control panel at the solar array system.

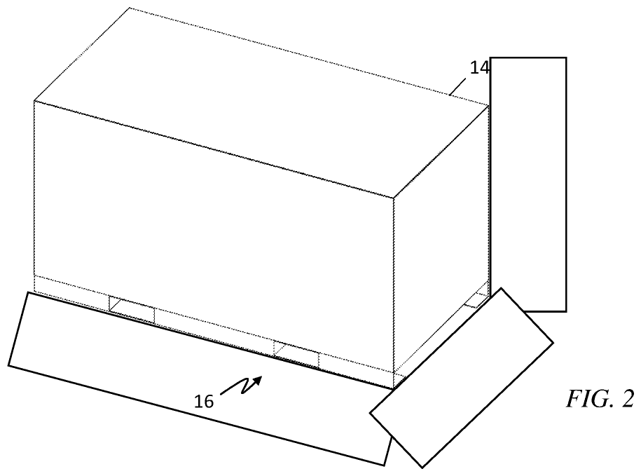

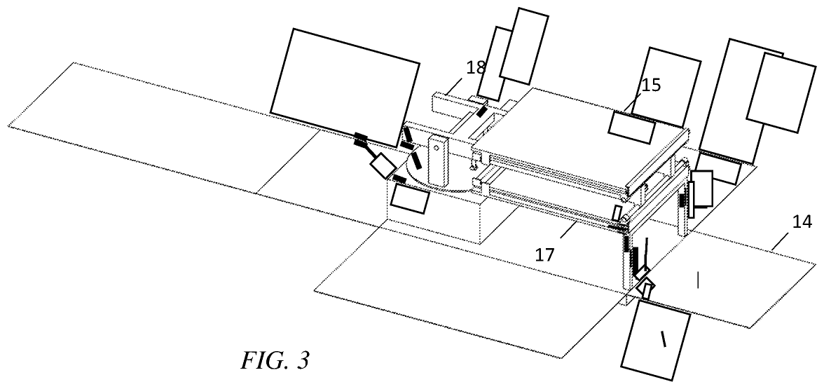

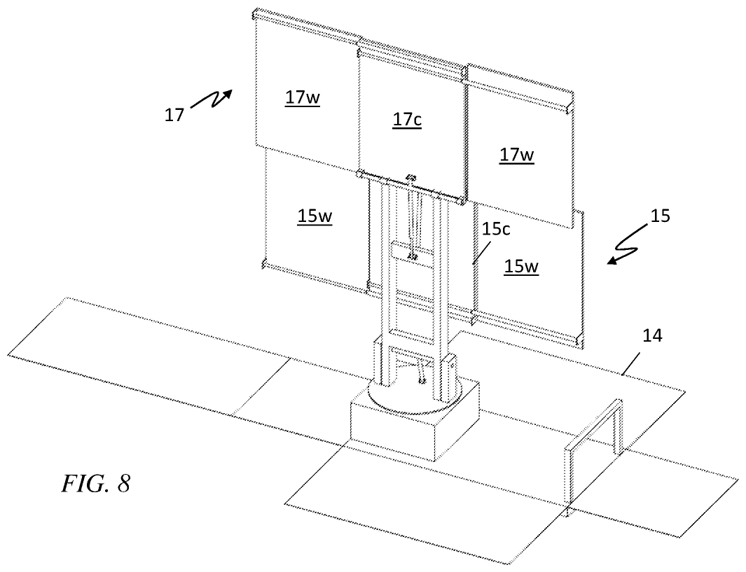

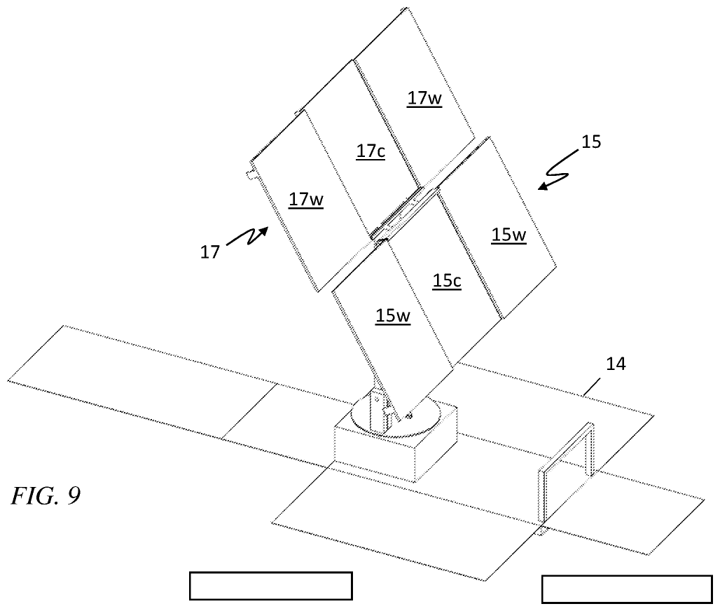

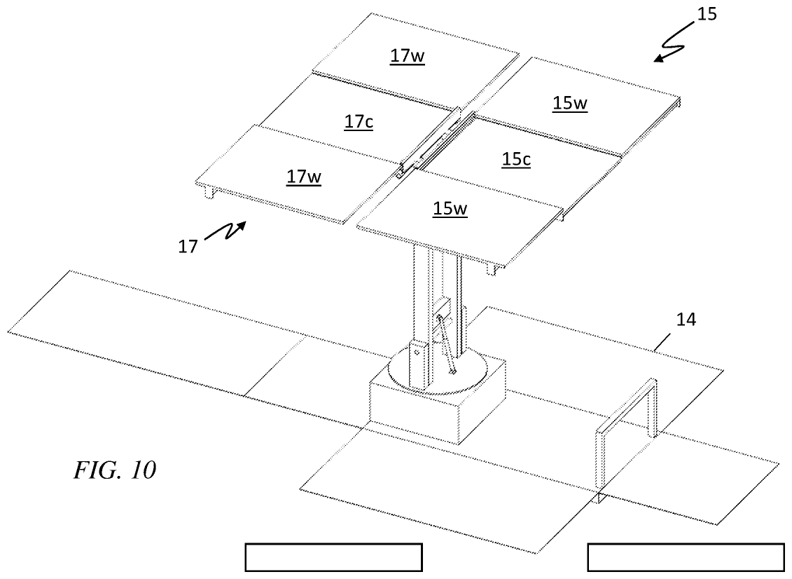

FIGS. 2-10 are perspective views of an exemplary embodiment of a self-contained self-stowing and self-deployable automatic tracking solar panel system 10 in various stages of deployment according to the teachings of the present disclosure. The present invention overcomes the limitations of prior art fossil-fuel and solar power supplies by providing a collapsible, self-stowing, self-deploying, dual-axis solar tracking, self-contained, ready-to-use, six full-size solar panel solar power system.

Referring to FIGS. 2-10, the solar panel arrays 15 and 17 are housed in a permanent shipping crate or container 14 that is weather-tight and preferably contains stringers 16 at the bottom to facilitate lifting and transportation by a forklift. The shipping crate 14 may further include pop-up eye rings at its four corners enabling the crate to be lifted using a chain or sling. The crate 14 is preferably under 8′ wide, allowing for efficient transport via traditional tractor-trailer or by ocean container. The deployment of the system 10, beginning with opening the crate 14 by actuators that are activated by a security-coded signal sent from a software application executing on a computing device such as a mobile phone and wirelessly communicated by cellular network or via satellite. The crate-opening and deployment actuators operate using electricity supplied by a 12v DC battery onboard inside the shipping container 14. Although the crate 14 is shown in the figures as opening completely with all of the sides becoming flat on the ground, the system 10 may be deployed by opening the top horizontal side of the crate 14 with one or more of the vertical sides of the crate 14 remaining vertical. The top side may lift and flip open or may slide along parallel rails to reveal the opening. As described above, system deployment may be carried out due to a predetermined schedule, due to detection of sunny weather, upon user command, or due to a combination of factors.

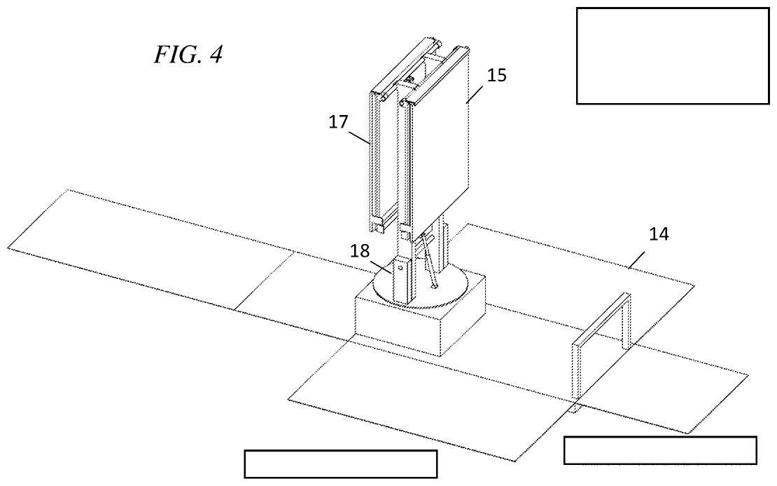

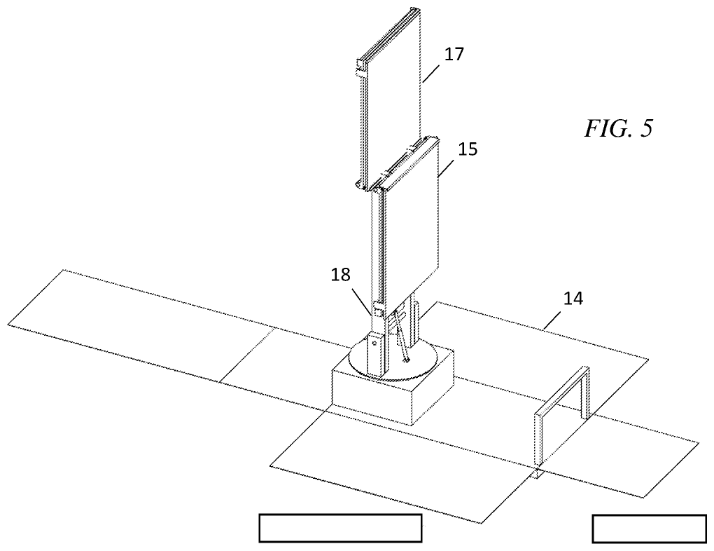

As shown in FIG. 4, the system 10 includes one or more central columns 18 that are raised by actuators and made vertical from its stowed horizontal position. Two solar-panel arrays 15 and 17 are attached to the central column 18 and can be raised and lowered independently of each other by actuators, as shown in FIG. 5. Although FIG. 5 shows an embodiment that includes two solar arrays, additional solar arrays may be included, where the solar arrays are stacked and overlapping while in the stowed position, and the solar arrays are disposed on, for example rails, that enable the overlapping solar arrays to slide apart and become non-overlapping.

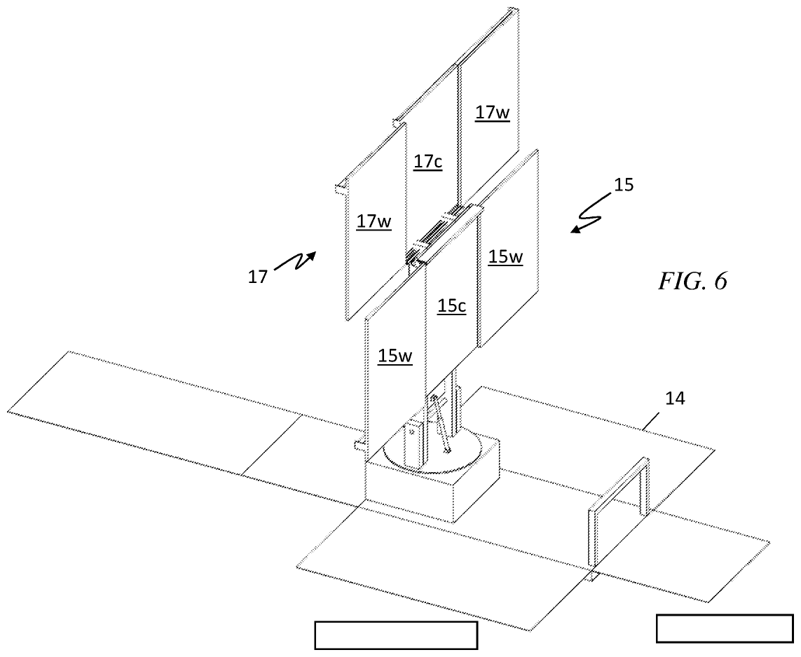

After the central column has reached its vertical position, one panel array is then raised so that they are disposed above the other panel array as shown in FIGS. 4 and 5. In this position, the wing panels overlap the center panels in each array. In FIG. 6, the wing panels of each array are actuated so that they move to either side of their respective center panels. They are placed on tracks so that they slide into position. The wing solar panels are thus deployed so that all of the solar panels can be moved and oriented as a unit. Alternately, the wing panels can be deployed before the first panel array is raised above the second array.

As shown in FIGS. 6-10, each solar array 15 and 17 may include one or more center panels 15c and 17c and one or more “wing” side panels 15w and 17w that can be extended to each side of the center panel(s), by actuators after the central column 18 has been fully raised to its deployed position, which is vertical or nearly vertical. In an alternate embodiment, the solar array may include two center panels and two wing panels on each side.

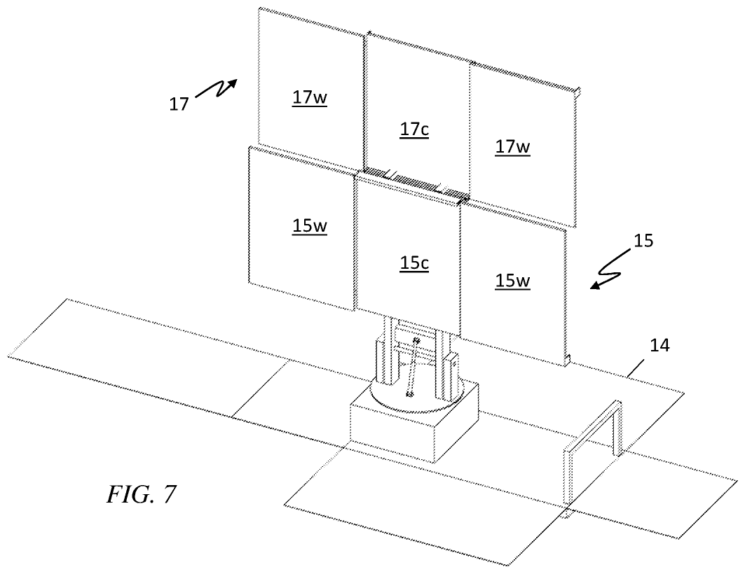

As shown in FIGS. 7-10, the solar panel arrays can be tilted from the horizontal plane to the vertical plane, so that the solar panels can be placed in a more optimal orientation to incident sunlight. One or more sensors may be used to determine the current position of the wing panels, solar arrays, etc. An optional rotational platform supports the central column to enable the azimuth orientation of the solar arrays. The system 10 further includes properly sized actuators, power circuitry, power devices, and electrical outlets in a variety of voltages and receptacle configurations.

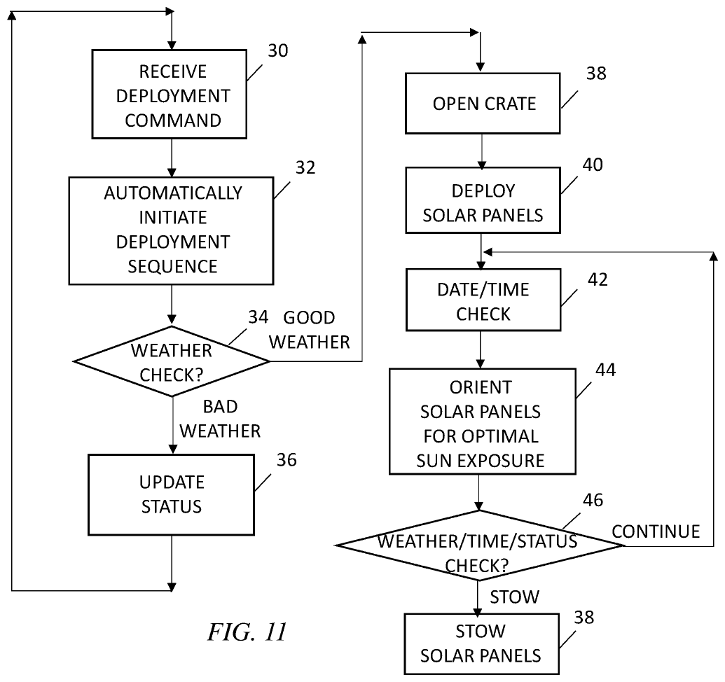

FIG. 11 is a simplified flowchart of an exemplary embodiment of a self-contained self-stowing and self-deployable automatic tracking solar panel method according to the teachings of the present disclosure. In block 30, a solar array deployment command/instruction was received. The deployment command may have originated from a command issued/entered by a user contemporaneously or in advance, or a scheduled daily deployment. In block 32, the deployment sequence is initiated. Prior to deployment, a weather check is performed in block 34. The weather check may be accomplished by receiving weather data from publicly available sources via the Internet. If the weather is bad, such as rainy or stormy, then the system status is updated to indicate that deployment is postponed or canceled due to inclement weather, as shown in block 36. The status information may be transmitted to the user's computing device and presented to the user as an alert. If the weather is good, then the actuators and motors are automatically energized to open the storage crate, as shown in block 38. In block 40, the solar arrays are expanded to deploy the solar panels so that they are no longer stacked in their overlapping stowed position. A date and time check is then performed in block 42 so that the location of the sun in the sky is determined, and that the solar panel orientation may be determined and attained. In block 44, the solar panels are then oriented for optimal sun exposure. In block 46, the system periodically performs a weather and time check to determine whether the solar arrays should remain deployed and to continue to orient them to maintain optimal orientation. If the weather is no longer optimal for solar generation or a pre-scheduled stow time has been reached, or a stow command has been received, then the solar panels are automatically returned to their stow position and stored within the storage crate where they are protected from inclement weather.

The features of the present invention which are believed to be novel are set forth below with particularity in the appended claims. However, modifications, variations, and changes to the exemplary embodiments described above will be apparent to those skilled in the art, and the self-contained self-stowing and self-deployable automatic tracking solar panel system described herein thus encompasses such modifications, variations, and changes and are not limited to the specific embodiments described herein.

What is claimed is:

1. An automated self-contained solar panel system comprising:
a weather-tight shipping crate having a top side, bottom, and four vertical sides;
a central column;
a first solar array having a center solar panel with a wing panel attached to a first side of the central column;
a second solar array having a center solar panel with a wing panel attached to a second side of the central column;
a first plurality of motors coupled to the shipping crate, central column and first and second solar arrays configured to place the shipping crate, central column and center and wing panels of the first and second solar arrays in one of stowed and deployed positions;
a second plurality of motors coupled to the central column and first and second solar arrays configured to place the central column and the first and second solar arrays in an optimal altitude orientation to receive solar energy; and
a controller in communication with the first and second plurality of motors and configured to:
automatically control the first plurality of motors to place the shipping crate, central column, and solar panels in a deployed position in response to receiving a deployment command;
automatically control the second plurality of motors to orient the solar panels in an optimal altitude direction to receive solar energy in response to determining a time when the shipping crate, central column, and solar panels are in the deployed position; and
automatically control the first and second plurality of motors to place the shipping crate, central column, and the solar panels in a stowed position in response to receiving one of a stow command and an inclement weather forecast.

2. The system of claim 1, wherein the first and second solar arrays each has at least one wing panel attached to either side of the center solar panel.

3. The system of claim 1, wherein the first and second solar arrays each includes at least two center solar panels.

4. The system of claim 1, further comprising a third plurality of motors coupled to the central column configured to orient the solar arrays in an optimal azimuth orientation.

5. The system of claim 1, wherein the wing panels are mounted on rails enabling slidable engagement with the center solar panel.

6. An automated solar panel deployment method comprising:
receiving a deployment command;
automatically beginning a deployment sequence in response to the deployment command and receiving a good weather forecast, the deployment sequence comprising:
automatically actuating a first plurality of motors configured to open a shipping crate to expose a stowed solar array system;
automatically actuating a second plurality of motors configured to raise a central column to a vertical position;
automatically actuating a third plurality of motors configured to elevate a first solar array attached to one side of the central column above a second solar array attached to another side of the central column;
automatically actuating a fourth plurality of motors configured to extend the first and second solar arrays so that left and right side panels overlapping a center panel in the stowed position in each solar array are moved to the deployed position, where the deployed solar arrays may be oriented as a unit; and
automatically actuating at least one motor configured to tilt the deployed solar arrays to orient the solar arrays for single-axis exposure to solar energy.

7. The method of claim 6, further comprising:
automatically beginning a stow sequence in response to receiving one of a stow command and an inclement weather forecast, the stow sequence comprising:
contracting the first and second solar arrays to a vertical oprientation;
contracting the first and second solar arrays so that the left and right side panels overlap the center panel in each solar array;
lowering the central column to its stowed orientation; and
closing the shipping crate to form a weather-tight housing for the stowed solar array system.

8. The method of claim 6, further comprising automatically actuating a motor configured to rotate the central column in response to the geographical location to orient the deployed solar arrays in an optimal azimuth position for optimal exposure to solar energy.

9. An automated self-contained solar panel system comprising:
a weather-tight storage crate having a top side, bottom, and four vertical sides;
a first solar array having a primary solar panel mounted on a column and having at least one secondary solar panel slidably engaged with the primary solar panel;
at least one second solar array having a primary solar panel mounted on the column and having at least one secondary solar panel slidably engaged with the primary solar panel, the solar panels of the at least one secondary solar array overlapping the solar panels of the primary solar array in a stowed position, and the solar panels of the at least one secondary solar array extending beyond and not overlapping the solar panels of the primary solar array in a deployed position;
the first solar array and at least one second solar array being automatically expandable into a plane of non-overlapping solar panels when in a deployed position;
the first solar array and at least one second solar array being automatically orientable to attain and maintain an optimal solar receiving position; and
the first solar array and at least one second solar array being automatically stowed entirely within the weather-tight storage crate when in the stowed position.

10. The system of claim 9, further comprising a first plurality of motors coupled to the storage crate, column, the first solar array, and the at least one second solar array configured to place the storage crate, column, and primary and secondary panels of the first and second solar arrays in one of stowed and deployed positions.

11. The system of claim 9, further comprising a second plurality of motors coupled to the column, the first solar array, and the at least one second solar array configured to place the column, the first solar array, and the at least one second solar array in an optimal orientation to receive solar energy.

12. The system of claim 10, further comprising a controller in communication with the first plurality of motors.

13. The system of claim 9, wherein the first and second solar arrays each has at least one secondary solar panel attached to either side of the primary solar panel.

14. The system of claim 9, wherein the first and second solar arrays each includes at least two primary solar panels.

15. The system of claim 9, further comprising a third plurality of motors coupled to the column configured to orient the solar arrays in an optimal azimuth orientation.

16. The system of claim 9, wherein the secondary solar panels are mounted on rails enabling slidable engagement with the primary solar panel.
